(19) United States
(12) Patent Application Publication
(10) Pub. No.: US 2016/0147630 A1
(43) Pub. Date: May 26, 2016

(54) METHOD AND SYSTEM OF DETECTING ABNORMAL POWER CONSUMPTION

(71) Applicant: Chiun Mai Communication Systems, Inc., New Taipei (TW)

(72) Inventors: CHIA-JUNG HU, New Taipei (TW); KAI-HSI YANG, New Taipei (TW); TAI-CHUAN CHEN, New Taipei (TW); LI-BIN SHEN, New Taipei (TW)

(21) Appl. No.: 14/694,565

(22) Filed: Apr. 23, 2015

(30) Foreign Application Priority Data
Nov. 26, 2014 (CN) 201410697253.9

(51) Int. Cl. G06F 11/30; G06F 11/34

(52) U.S. Cl. CPC G06F 11/3062; G06F 11/3495

(57) ABSTRACT

Provided is a method of detecting abnormal power consumption of an electrical device during a standby time period. The electrical device includes an operating system. The method includes: obtaining a first system log of the operating system at a first time point; obtaining a second system log of the operating system at a second time point; determining whether the electrical device is in a standby mode from the first time point to the second time point by comparing the first system log with the second system log; if the electrical device is in the standby mode, determining whether the operating system is in a sleep mode; if the operating system is not in the sleep mode, analysing the system log of the operating system from the first time period to the second time period, so as to obtain and store an abnormal power consumption information.

### FIELD

The subject matter herein generally relates to power management technologies, and particularly to a method and a system of detecting abnormal power consumption.

### BACKGROUND

Nowadays, electrical devices have more and more application programs and background service programs. Some of the application programs and background service programs are still running when the electrical devices are in a standby mode and consumes power of the electrical devices, such that battery life of the electrical devices is short.

### BRIEF DESCRIPTION OF THE DRAWINGS

Implementations of the present technology will now be described, by way of example only, with reference to the attached figures.

FIG. 1 is a block diagram of a system of detecting abnormal power consumption according to an embodiment of the instant disclosure.

FIG. 2 is a flowchart illustrating a method of detecting abnormal power consumption according to an embodiment of the instant disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

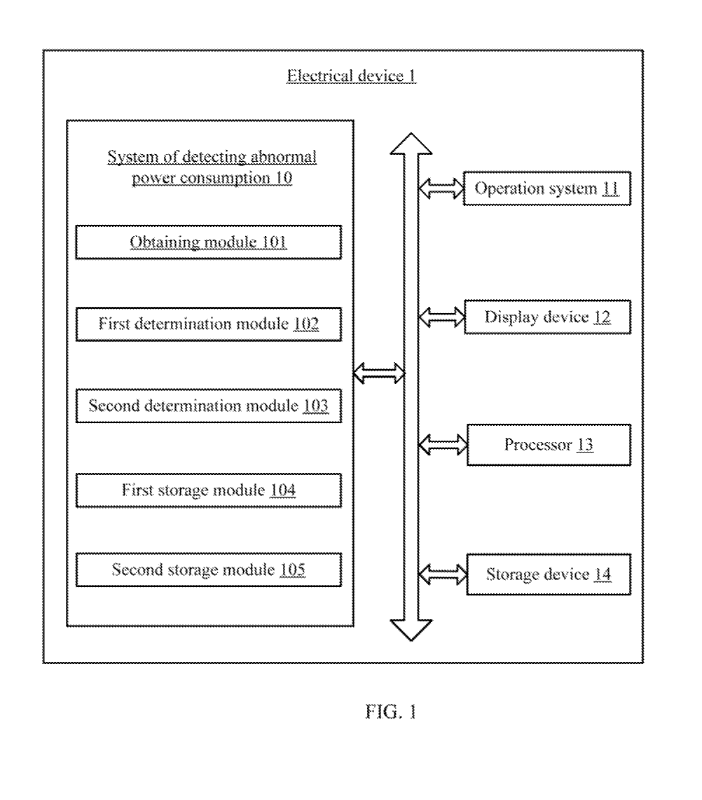

Referring to FIG. 1, a block diagram for a system 10 of detecting abnormal power consumption is shown. The system 10 is stored and runs in an electrical device 1. The electrical device 1 can be a portable electrical device, for example, cell phone, tablet computer. The electrical device 1 includes, but not limited to, an operating system 11, a display device 12, a processor 13 and a storage device 14. The operating system 11 has a record function, for recording all operations of application programs and of background service programs stored in the operating system 11, including system log. In the illustrated embodiment, the operating system 11 is Android system. When obtaining the system log of a time period, the system 10 obtains the system log of the start of the time period and the system log of the end of the time period, and compares the system log of the start of the time period with the system log of the end of the time period to obtain the system log of the time period. The system log includes the information about on and off of the display device 12.

The system 10 obtains the system log once in a predetermined time interval and analyses the obtained system log to determine the standby time period of the electrical device 1. The system 10 analyses the system log in the standby time period of the electrical device 1, so as to determine the application programs and the background service programs that stop the operating system 11 from staying the sleep mode. In the illustrated embodiment, when the display device 12 is in the off state, the electrical device 1 is in the standby mode. Therefore, the standby time period refers to the time period from the time that the display device 12 is turned off to the time that the display device 12 is turned on again.

The storage device 14 can be the RAM of the electrical device 1 or other external storage devices, for example, smart media cards, secure digital cards, flash cards, etc. The storage device 14 stores program instructions and data of the system 10 and the operating system 11.

The system 10 includes an obtaining module 101, a first determination module 102, a second determination module 103, a first storage module 104, and a second storage module 105. The word “module,” as used hereinafter, refers to a collection of software instructions which are stored in the storage device 14 and can be executed by the processor 13.

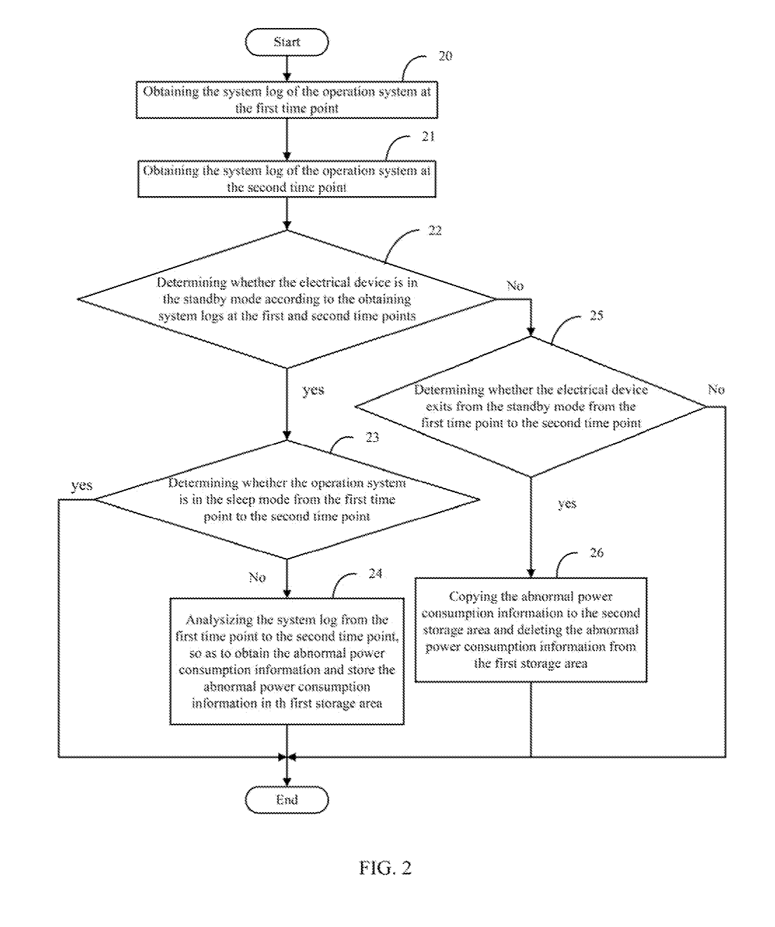

Referring to FIG. 2, a flowchart is presented in accordance with an example embodiment. An example method is provided by way of example, as there are a variety of ways to carry out the method. The example method described below can be carried out using the configurations illustrated in FIG. 2, for example, and various elements of these figures are referenced in explaining example method. Each block shown in FIG. 2 represents one or more processes, methods or subroutines, carried out in the example method. Furthermore, the illustrated order of blocks is illustrative only and the order of the blocks can change according to the present disclosure. Additional blocks can be added or fewer blocks may be utilized, without departing from this disclosure. The example method can begin at block 20.

At block 20, the obtaining module 101 obtains the system log of the operating system 11 at a first time point. In the illustrated embodiment, the system 10 obtains the system log of the operating system 11 once in a predetermined time interval (e.g. 3 minutes). The system 10 analyses the system logs at two neighboring time points to determine whether there are application programs or background service programs abnormally consuming power of the electrical device 1. The time point that the obtaining module 101 obtains the system log of the operating system 11 is called as detection time point.

At block 21, the obtaining module 101 obtains the system log of the operating system 11 at a second time point. The time period from the first time point to the second time point is several times longer than the predetermined time interval. In the illustrated embodiment, the system 10 obtains the system log of the operating system 11 once in the predetermined time interval (e.g., 3 minutes). However, when the operating system 11 is in the sleep mode, the system 10 cannot obtain the system log of the operating system 11. Therefore, the time period from the first time point to the second time point needs to be several times longer than the predetermined time interval.

At block 22, the first determination module 102 determines whether the electrical device 1 is in the standby mode in the time period from the first time point to the second time point by comparing the system log of the operating system 11 at the first time point with the system log of the operating system 11 at the second time point. If yes, block 23 is perform; otherwise, block 25 is perform. In the illustrated embodiment, the first determination module 102 analyses the system logs at the first and second time points, so as to obtain the states of the display device 12 at the first and second time points. If the display device 12 is in the off state from the first time point to the second time point, it is determined that the electrical device 1 is in the standby mode from the first time point to the second time point.

It is noted that if the electrical device 1 is in the standby mode in part of the time period from the first time point to the second time point, the system 10 would not determine that there are abnormal power consumption information. If there are less than two detection time points during the time period, the system 10 cannot determine that there are abnormal power consumption information. Therefore, the standby time period includes at least two detection time points.

At block 23, the second determination module 103 determines whether the operating system 11 is in the sleep mode during the time period from the first time point to the second time point when the electrical device 1 is in the standby mode. If the operating system 11 is not in the sleep mode, block 24 is perform; otherwise, the flowchart is ended. The system log of the operating system 11 has no information about whether the operating system 11 is in the sleep mode, and however the operating system 11 has functions through which the second determination module 103 can obtain the sleep time period of the operating system 11. The second determination module 103 compares the operating system 11 during the sleep time period with the operating system 11 from the first time period to the second time period, so as to determine whether the operating system 11 is in the sleep mode from the first time point to the second time point.

For example, the operating system 11 is in the sleep mode during the time period of 08:21:00-08:28:00, the system 10 obtains the system log of the operating system 10 once in the time interval of 3 minutes, and the first time point is 08:20:00 and the second time point is 08:29:00. The operating system 11 is in the sleep mode at the detection time points 08:23:00 and 08:26:00, so the system 10 cannot obtain the system log of the operating system 11 at 08:23:00 and 08:26:00, but can obtain the system log at 08:29:00. By comparing the system log at 08:20:00 with the system log at 08:29:00, the second determination module 103 determines that the operating system 11 is not in the sleep mode from the first time point to the second time period. If the operating system 11 is in the sleep mode from 08:20:00-08:29:00, the second determination module 103 determines that the operating system 11 is in the sleep mode from the first time point to the second time point.

At block 24, the first storage module 104 analyses the system log of the operating system 11 from the first time point to the second time point, to obtain the abnormal power consumption information and store the abnormal power consumption information in a first storage area of the storage device 14. The abnormal power consumption information refers to information about the application programs and background service programs that stop the operating system 11 from staying in the sleep mode in the standby time period. In the illustrated embodiment, the application programs and background service programs include operations that stop the operating system 11 from staying in the sleep mode, and these operations can be requesting wake lock or unreleased wake lock, transmit or receive data to wake the operating system 11 up. Therefore, the abnormal power consumption information refers to the application programs and background service programs that perform these operations from the first time point to the second time point.

At block 25, the second storage module 105 determines whether the electrical device 1 exits from the standby mode from the first time point to the second time point. If yes, block 26 is perform; otherwise, the flowchart is end.

In the illustrated embodiment, the second storage module 105 determines whether there is abnormal power consumption information in the first storage area, so as to determine whether the electrical device 1 exits from the standby mode from the first time point to the second time point. The second storage module 105 deletes the abnormal power consumption information from the first storage area at the first detection time point after the electrical device 1 exiting from the standby mode.

At block 26, the second storage module 105 copies the abnormal power consumption information to a second storage area of the storage device 14 and deletes the abnormal power consumption information from the first storage area at the first time point or before the first time point. Therefore, the abnormal power consumption information storing in the first storage area does not exit at the second time point.

In other embodiments, the second storage module 105 can also determine whether the electrical device 1 exits from the standby mode from the first time point to the second time point through other ways, for example, through logical variable. When the first storage module 104 stores the abnormal power consumption information in the first storage area, it is determined that the electrical device 1 is in the standby mode and the logical variable is set as “1.” When the second storage module 105 deletes the abnormal power consumption from the first storage area, it is determined that the electrical device 1 just exits from the standby mode and the logical variable is changed back into the initial value “0.” When the electrical device 1 exits from the standby mode, the logical variable is “1” at the first detection time point, the second storage module 105 can determine whether the logical variable is “1,” to determine whether the electrical device 1 exits from the standby mode from the first time point to the second time point.

In one embodiment, the second storage module 105 reminds users through a predetermined way whether the electrical device 1 has abnormal power consumption during the standby time period and inquires whether the users want to check the abnormal power consumption information. In the illustrated embodiment, the predetermined way is that the electrical device 1 displays a floating window on the display device 12.

The system 10 run in a periodic cycle and blocks 20-26 are a cycle.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method of detecting abnormal power consumption, during a standby time period, of an electrical device having an operating system, the method comprising:
obtaining, at a first time point, a first system log of the operating system;
obtaining, at a second time point, a second system log of the operating system;
determining whether the electrical device is in a standby mode from the first time point to the second time point by comparing the first system log with the second system log;
if the electrical device is in the standby mode:
determining whether the operating system is in a sleep mode from the first time point to the second time point;
if the operating system is not in the sleep mode:
analysing the system log of the operating system from the first time period to the second time period, so as to obtain an abnormal power consumption information and store the abnormal power consumption information in a first storage area of the electrical device.

2. The method of claim 1, comprising: determining whether the electrical device exits from the standby mode from the first time point to the second time point if it is determined that the electrical device is not in the standby mode.

3. The method of claim 2, comprising: copying the abnormal power consumption information to a second storage area of the electrical device and deleting the abnormal power consumption information from the first storage area if it is determined that the electrical device exits from the standby mode from the first time point to the second time point.

4. The method of claim 2, wherein whether the electrical device exits from the standby mode from the first time point to the second time point is determined through logical variable.

5. The method of claim 1, comprising:
reminding users that the electrical device has abnormal power consumption through a predetermined way.

6. The method of claim 5, comprising:
inquiring whether the users want to check the abnormal power consumption information.

7. The method of claim 5, wherein the electrical device comprises a display device and the predetermined way is that the electrical device displays a floating window on the display device.

8. The method of claim 1, wherein the abnormal power consumption information is the information about application programs and background service programs that stop the operating system from staying in the sleep mode in the standby time period.

9. An electrical device, comprising:
a processor;
a display device;
a storage device; and
one or more programs that are stored in the storage device and are executed by the processor, the one or more programs comprising:
an operating system;
an obtaining module that obtains a first system log of the operating system at a first time point and a second system log of the operating system at a second time point;
a first determination module that determines whether the electrical device is in a standby mode from the first time point to the second time point by comparing the first system log with the second system log;
a second determination module that determines whether the operating system is in a sleep mode from the first time point to the second time point when the electrical device is in the standby mode; and
a first storage module that analyses the system log of the operating system from the first time point to the second time point, so as to obtain an abnormal power consumption information and store the abnormal power consumption information in a first storage area of the storage device when it is determined that the operating system is not in the sleep mode.

10. The electrical device of claim 9, wherein the one or more programs comprises a second storage module that determines whether the electrical device exits from the standby mode from the first time point to the second time point.

11. The electrical device of claim 10, wherein the second storage module determines whether there is abnormal power consumption information in the first storage area, so as to determine whether the electrical device exits from the standby mode from the first time point to the second time point.

12. The electrical device of claim 10, wherein the second storage module determines whether the electrical device exits from the standby mode from the first time point to the second time point through logical variable.

13. The electrical device of claim 10, wherein the second storage module copies the abnormal power consumption information to a second storage area of the storage device and deletes the abnormal power consumption information from the first storage area if it is determined that the electrical device exits from the standby mode from the first time point to the second time point.

14. The electrical device of claim 10, wherein the second storage module reminds users through a predetermined way whether the electrical device has abnormal power consumption during the standby time period and inquires whether the users want to check the abnormal power consumption information.

15. The electrical device of claim 14, wherein the predetermined way is that the electrical device displays a floating window on the display device.

16. The electrical device of claim 9, wherein the obtaining module obtains the system log of the operating system once in a predetermined time interval.
